(19) United States
(12) Patent Application Publication
(10) Pub. No.: US 2004/0174366 A1
(43) Pub. Date: Sep. 9, 2004

(54) Generation of images

(76) Inventors: Drazen Lenger, Lane Cove (AU); Zoran Tomicic, Lane Cove (AU)

Correspondence Address: GREENBERG TRAURIG LLP, 2450 COLORADO AVENUE, SUITE 400E, SANTA MONICA, CA, 90404, US

(21) Appl. No.: 10/757,088

(22) Filed: Jan. 13, 2004

(30) Foreign Application Priority Data
Jan. 17, 2003 (AU) 2003901844

(51) Int. Cl. G06T 15/70

(52) U.S. Cl. 345/473

(57) ABSTRACT

A system for generating animated images comprises a data encoder for compressing data relating to the animated image to be generated using a predetermined compression format. A transparency information component is embodied in the data, the transparency information component providing information relating to a degree of transparency of a part of the image. An identification component is contained in the data that identifies to a data decoder the compression format that has been used to compress the data.

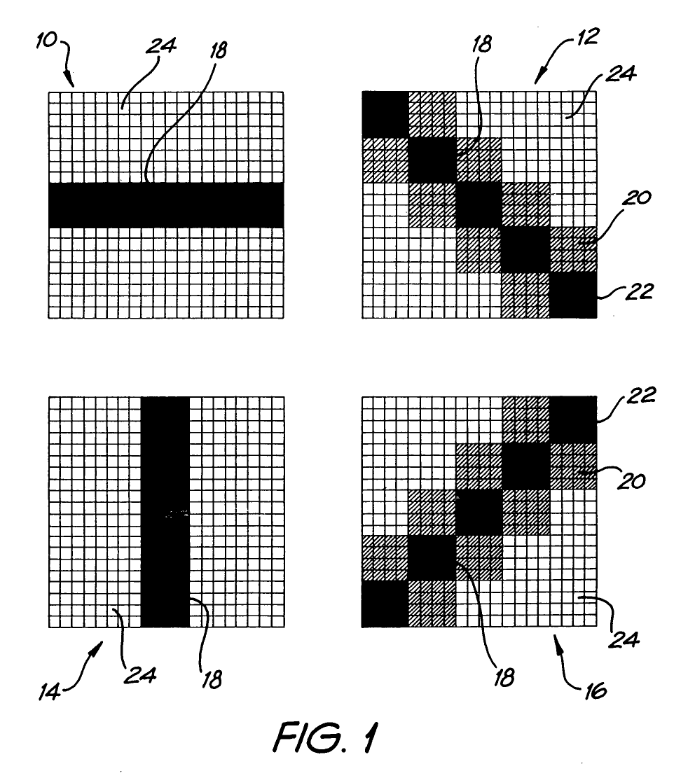

### BACKGROUND OF THE INVENTION

With the advent of electronic gaming machines using a video display unit for displaying information relating to the gaming machine, there has been a proliferation of techniques used to convey information. Amongst the techniques which are used are the use of animated characters, commonly called “sprites”, for conveying information as well as for providing entertaining visual content to players of the gaming machines. For example, the applicant's well known Mr Cashman® (Mr Cashman is a Registered Trade Mark of Aristocrat Technologies Pty Ltd) is made up of an animated device of 400×400 pixels. Approximately 100 variations of the Mr Cashman sprite need to be stored. The images are stored in an uncompressed format in a video memory of the gaming machine and, as a result, use about half of the video memory's capacity of approximately 32 MB. This is required so that the sprites can be rendered, one at a time, at different positions on the display screen of the electronic gaming machine as required over different time intervals. The use of almost half of the video memory's capacity and the manner in which the sprites are rendered results in an inefficient operation of the gaming machine.

Various software techniques for generating images are known. A commonly used technique is a FLIC file format. The FLIC file format is a temporal compression technique which is able to provide efficient coding/decoding of a sequence of colored images using the primary colors of blue, green, red (BGR).

Rather than use the video memory of the gaming machine, the compression technique can be run from any non-volatile storage device, such as an EPROM, of the gaming machine resulting in quicker and more efficient operation of the gaming machine.

A problem with the FLIC file format is that the image created is a totally opaque image and degrees of transparency of the image cannot be accommodated in the present FLIC file format.

### SUMMARY OF THE INVENTION

According to a first aspect of the invention, there is provided a system for generating animated images, the system comprising

a data encoder for compressing data relating to the animated image to be generated using a predetermined compression format;

a transparency information component embodied in the data, the transparency information component providing information relating to a degree of transparency of a part of the image; and

an identification component contained in the data that identifies to a data decoder the compression format that has been used to compress the data.

The system and method of the invention are intended particularly for use in generating animated images to be displayed on a display of a gaming apparatus, in particular, but not necessarily exclusively, a gaming machine. A gaming apparatus is to be understood to include an apparatus that does not require the wagering of a stake in order to play the game and further includes an apparatus which is connectable to a network.

The display can be implemented in any one of a number of ways such as, for example, by way of a cathode ray tube, a liquid crystal display, a plasma screen display, or the like. The invention is not limited to any particular type of display used in the gaming apparatus.

The software may thus be stored in a non-volatile storage device of the gaming machine, for example, an EPROM of the gaming machine.

The compression format used by the data encoder and the data decoder may be a FLIC file format. The FLIC file format is a format where repeated matter in a sequence of images is not stored each time the image is compressed thereby considerably increasing the amount of information which can be stored and speeding up the processing time. The FLIC file format makes use of the normal primary color spectrum of blue, green, red (BGR) in a palette of 256 colors to provide all required colors for images to be generated.

The transparency information component may embody ALPHA information incorporated in the FLIC file format so that, together with color information in the FLIC file format, a data word specifying color and transparency of each pixel of the image is created.

Those skilled in the art will appreciate that a FLIC file consists of a plurality of frames. Each frame contains image data and, possibly, palette data or other data. Each frame is structured in a hierarchy of chunks. A chunk may contain a fixed part and a variable part. The fixed part contains the type and size of chunk while the remainder has no fixed format, depending on the chunk type.

The identification component may be an information chunk incorporated in a first chunk of a first frame of the FLIC file format to enable the decoder to determine that a different FLIC file format is being used. The information chunk may contain information as to whether or not the FLIC file format being used does contain any ALPHA information. Further, the information chunk may contain information relating to a color palette used in the FLIC file format.

Where more than one color palette is available for use, a palette change chunk may be included in the data following the information chunk to enable a palette change to be effected on the fly.

According to a second aspect of the invention, there is provided a method of generating animated images which includes the steps of

compressing data relating to the animated image to be generated using a predetermined compression format;

including a transparency information component in the data for enabling a determination to be made as to a degree of transparency of a part of the image; and

incorporating an identification component in the data that identifies to a data decoder the compression format that has been used to compress the data.

The method may include using a FLIC file format as the compression format.

Further, the method may include embodying the transparency information component as ALPHA information incorporated in the FLIC file format so that, together with color information in the FLIC file format, a data word specifying color and transparency of each pixel of the image is created.

The method may include implementing the identification component as an information chunk incorporated in a first chunk of a first frame of the FLIC file format to enable the decoder to determine that a different FLIC file format is being used. The method may include inserting in the information chunk information as to whether or not the FLIC file format being used does contain any ALPHA information. In addition, the method may include inserting in the information chunk information relating to a color palette used in the FLIC file format.

Where more than one color palette is available for use, the method may include including a palette change chunk in the data following the information chunk to enable a palette change to be effected on the fly.

According to a third aspect of the invention, there is provided a method of modifying software used in the generation of animated images, the method including inserting a transparency information component and an identification component into a part of a data file, the identification component identifying to a data decoder the compression format that has been used to compress the data.

The data file may be a FLIC format file and the method may include inserting the transparency information component into at least one chunk of the FLIC file.

The method may include implementing the transparency information component by way of an ALPHA technique by incorporating an ALPHA component in the data file to be compressed and decompressed in generating a sequence of images. An ALPHA component is relevant when a source image is rendered on top of an existing (destination) image. The ALPHA technique uses 256 degrees of transparency. If the ALPHA component, A, equals zero it means that no source image is copied so that a pixel of the image is fully transparent. If A equals 255 it means that the source image pixel is fully opaque and therefore it replaces the destination pixel. Any other value in between represents a blending ratio between the source image and destination image. Usually, pixels on edges of animated objects have mid-range ALPHA values to blend with a background. All pixels outside the animated object have an ALPHA value of A=zero and, for a fully opaque image, all pixels within the animated object have an ALPHA value of A=255.

The data file of an existing FLIC file format consists of one byte per image pixel which is an index to a color palette that contains up to 256 colors in BGR format. However, the method may include modifying a data file of the FLIC file format to incorporate the ALPHA component by including a second byte of data relating to the ALPHA component.

Further, the method may include modifying a run chunk of the FLIC file format so that data following a chunk header is a full image that is compressed with one of word oriented run length encoding (RLE) and Huffman encoding. Where RLE is used, each packet of RLE data may consist of a count byte and at least one data word, a data word being sixteen bits. If the count byte is negative, its absolute value may be the number of data words to copy to the image. If the count byte is positive, the single data word that follows may be replicated by the absolute value of the count byte.

It is to be noted that sixteen bit pixels are never copied to a target decompression buffer. Rather, the method may include expanding the sixteen bit data word on the fly to BGRA (the primary color spectrum including an ALPHA component).

The method may include expanding the sixteen bit data word by using the least significant byte to get BGR information from a BGR color palette with the ALPHA component being taken from the most significant byte of the data word.

Further, the method may include inserting the identification component as an information chunk into a first chunk of a first frame of the FLIC file format. As described above, the existence of the information chunk may tell a decoder that a new FLIC file format is being used. Information contained in the information chunk may include the FLIC type, viz. where the FLIC type has no ALPHA component, the palette may have some pixels where the ALPHA component is other than fully opaque or that the FLIC type is a full ALPHA FLIC format having ALPHA information for every pixel so that the sub-chunks following are the modified chunks described above.

Still further, the method may include inserting a palette change chunk into the data file where more than one palette is contained in the information chunk. Any palette change may be done on the fly using the palette change chunk. The palette change chunk data may contain a single two byte number that specifies the palette numbers to be used.

The invention extends also to a data carrying signal which includes compressed data relating to an animated image to be displayed, the data incorporating color related information, transparency related information and an identification component embodied in chunk components of the data, the identification component identifying to a data decoder the compression format that has been used to compress the data.

The invention extends still further to a gaming apparatus which includes a game controller and a display, the game controller controlling the display of images related to a game played on the gaming machine on the display, the game controller including a system, as described above, for generating animated images to be displayed on the display.

### BRIEF DESCRIPTION OF THE DRAWINGS

The invention is now described by way of example with reference to the accompanying diagram which shows a series of four schematic screen displays illustrating a sequence of images, generated in accordance with the invention.

### DETAILED DESCRIPTION OF THE INVENTION

In the drawings reference numerals 10, 12, 14 and 16 illustrate a sequence of images generated and displayed, in accordance with an embodiment of the invention. As will be appreciated, the image is a line 18 which is rotated through 45° in each succeeding image of the sequence of images. Thus, the images 10-16 are a greatly simplified version of an image to be displayed, in use, on a video display unit of a gaming machine. Further, the images 10-16 are greatly magnified and, in fact, are five pixels by five pixels.

While the images 10-16 illustrated are shown in gray scale, the description will be based on the assumption that the line 18 is of a red color.

Bearing in mind that the illustrated images 10-16 are only 5×5 pixels, semitransparent pixels 10 are arranged on opposed sides of the pixels 22 of the diagonal lines 18 of the images 12 and 16 so that a blending is achieved between the line 18 and a background 24 of the image 12 or 16, as the case may be. The semitransparent pixels 20 minimize the “staircase-like” effect shown in a greatly exaggerated form in images 12 and 16 due to the illustrated increased magnification of the images 10-16 in the diagram.

In the generation of the images to be displayed on the video display unit of the gaming machine, a temporal compression technique is used which can accommodate transparency information. The technique used is a modified version of the FLIC file format.

Those skilled in the art will appreciate that a FLIC file consists of frames. Each frame contains image data and, possibly, palette data and/or other data. FLIC files are structured in a hierarchy of chunks. Each chunk contains a fixed part and a variable part. The fixed part of every chunk contains the type and the size of the chunk. The rest of the chunk has no fixed format but depends on the chunk type.

The modification to the FLIC file format incorporates modifying a byte run chunk as well as a Delta FLC chunk. In a standard FLIC file format, each pixel is described by 8 bits or a byte. This value is an index to a palette that contain up to 256 colors in BGR form.

With a standard byte run chunk, the data following a chunk header is a full image that is compressed with byte oriented run length encoding (RLE). The modification to the byte run chunk is to convert it to a word run chunk where a further 8 bits, or a byte, of transparency information is incorporated. The data following the chunk header is therefore a full image pixel that is compressed with word oriented RLE. In the word run chunk, each line of the image is compressed separately, starting from the top of the image. Each RLE packet consists of a count byte and one or more data words being 16 bit words containing color information and transparency information.

In this regard, it is to be noted that the transparency information used uses an ALPHA component. An ALPHA component is derived from a technique using 256 degrees of transparency. If the ALPHA component, A, has a value of zero it means that no source image is copied so that a pixel of the image is fully transparent. If the ALPHA component, A, has a value of 255 it means that the source image pixel is fully opaque and therefore it replaces the destination pixel. Any other value in between represents a blending ratio between the source image and destination image. Accordingly, the pixels 20 in the images 12, 16 have a mid range ALPHA component.

In the word run chunk, if a count byte is negative, its absolute value is the number of words, following the count byte, to copy to the image. This is referred to as a literal run. If the count byte is positive, the data word that follows the count byte is replicated by the absolute value of the count byte. This is referred to as a replicate run.

It is to be noted that a 16 bit pixel is never copied to a target decompression buffer. Rather, the compressed data are expanded on the fly to BGRA format by using the least significant bit to get BGR data from the palette while the ALPHA component is derived from the most significant bit of the word.

In standard FLIC file format, a Delta FLC chunk is used for indicating changes between one pixel and the next pixel to reduce the amount of data which needs to be compressed.

Once again, this chunk has a chunk header and the data following the chunk header is organized into lines with each line being organized into packets. Every line starts with one or more word-sized “opcodes”.

The first word following the chunk header is the number of lines in the chunk. This count does not include “skipped” lines. Each line starts with one or more opcodes where one of the opcodes is the packet count. The two most significant bits of the opcode give its type.

The RLE compression of the chunk is also word oriented with the first byte of each packet being the column skip count and the second byte being the RLE count byte. Zero or more data words follow the RLE count byte. If the count byte is positive, that number of words of data is copied to the image. If the count byte is negative one data word follows and the absolute value of the count byte indicates how many times that word must be replicated in the image.

The Delta FLC chunk of the conventional FLIC file format has been replaced by a Word Delta FLC chunk. The first part of the modified word Delta FLC chunk is the same as for a standard Delta FLC chunk but the data words following the RLE count byte are 16 bit words containing color information and transparency information.

As for the word run chunk, the 16 bit words are expanded on the fly to 32 bit BGRA values when decompressed.

A further modification to the FLIC file format is the inclusion of an information chunk. This chunk is the first chunk in the first frame. Its existence tells a decoder that a new FLIC file format is being used. The layout of the information chunk body is as follows:

| Field Name | Size | Description |
|---|---|---|
| FlicType | 2 bytes | Flic type: |
| | | RGB_FLIC(1)-FLIG does not have |
| | | alpha data, so the subchunks following |
| | | are BYTE_RUN and DELTA_FLC. All |
| | | palette entries have alpha component |
| | | equal to 0xff (fully opaque) |
| | | BYTE_ALPHA_FLIC(2) —similar as |
| | | above, only that in this case the palette |
| | | has some entries that have an alpha |
| | | component other than 0xff. |
| | | WORD_ALPHA_FLIC(3) —this is full |
| | | feature alpha FLIC that has 16-bit of |
| | | info for every pixel, so the subchunks |
| | | following are the modified word run |
| | | chunk and the delta FLC chunk. |
| HasAlpha | 2 bytes | A non-zero value indicates that FLIC |
| | | contains alpha data. |
| Npal | 2 bytes | Number of embedded palettes that |
| | | follow. Has to be at least 1. |
| PalOffset0 to | nPal*4bytes | Offsets (in bytes, calculated from the |
| PallOffsetN | | chunk body start) to the beginning of the |
| N=nPal-1 | | corresponding palette. Each palette |
| | | entry has 4 bytes (BGRA format). Note |
| | | that palette will always start on the |
| | | multiple of 4 bytes, so it can be read in- |
| | | place by the decoder. No other chunks |
| | | are guaranteed to be aligned. Usually |
| | | there is only one palette, so in that case |
| | | PallOffset0=10 |

In addition, a palette change chunk is included. The decoder assumes that the palette to be used is the first palette (which is usually the only palette) in the information chunk described above.

If, however, more than one palette is referred to in the information chunk, palette change on the fly is done using the palette change chunk. The body of the palette change chunk contains a single two byte number that specifies the palette number to which to switch. The value of the two byte number must be in the range zero to nPal−1.

The hex dump for the sequence of images 10-16 shown in the drawings is given below:

| | | | | | | | | | | | | | | | | | |
|---|---|---|---|---|---|---|---|---|---|---|---|---|---|---|---|---|---|
| 0000000 | 46 | 4c | 49 | 43 | 1b | 01 | 00 | 00 | 0a | 00 | 00 | 00 | 05 | 00 | 00 | 00 | ‘FLIC.......’ |
| 0000010: | 05 | 00 | 00 | 00 | 08 | 00 | 00 | 00 | 00 | 00 | 00 | 00 | ff | ff | ff | ff | ‘.................’ |
| 0000020: | 04 | 00 | 00 | 00 | 2c | 00 | 00 | 00 | 2c | 00 | 00 | 00 | 3d | 00 | 00 | 00 | ‘....,...,...=...’ |
| 0000030: | fa | f1 | 02 | 00 | 00 | 00 | 00 | 00 | 00 | 00 | 00 | 00 | 18 | 00 | 00 | 00 | ‘.................’ |
| 0000040: | 40 | 00 | 03 | 00 | 01 | 00 | 01 | 00 | 0a | 00 | 00 | 00 | 00 | 00 | 00 | ff | ‘@.............’ |
| 0000050: | 00 | 00 | ff | ff | 15 | 00 | 00 | 00 | 49 | 00 | 05 | 00 | 00 | 05 | 00 | 00 | ‘................’ |
| 0000060: | 05 | 01 | ff | 05 | 00 | 00 | 05 | 00 | 00 | 4a | 00 | 00 | 00 | fa | f1 | 01 | ‘.........J......’ |
| 0000070: | 00 | 00 | 00 | 00 | 00 | 00 | 00 | 00 | 00 | 3a | 00 | 00 | 00 | 4a | 00 | 05 | ‘.............J..’ |
| 0000080: | 00 | 01 | 00 | 00 | 02 | 01 | ff | 01 | 3b | 01 | 00 | 00 | 03 | 01 | 3b | 01 | ‘........;.....;.’ |
| 0000090: | ff | 01 | 3b | 02 | 00 | 00 | 02 | 00 | 00 | 01 | 3b | 01 | 02 | 01 | 3b | 00 | ‘..;.......;...;.’ |
| 00000a0: | 00 | 01 | 00 | 02 | 03 | 01 | 3b | 01 | ff | 01 | 3b | 01 | 00 | 03 | 02 | 01 | ‘......;...;.....’ |
| 00000b0: | 3b | 01 | ff | 4a | 00 | 00 | 00 | fa | f1 | 01 | 00 | 00 | 00 | 00 | 00 | 00 | ‘;..J............ |
| 00000c0: | 00 | 00 | 00 | 3a | 00 | 00 | 00 | 4a | 00 | 05 | 00 | 02 | 00 | 00 | fe | 00 | ‘.......J........’ |
| 00000d0: | 00 | 00 | 01 | 01 | ff | 02 | 00 | 00 | fe | 00 | 00 | 00 | 01 | 01 | ff | 02 | ‘................ |
| 00000e0: | 00 | 01 | 01 | 00 | 00 | 01 | 01 | 00 | 00 | 02 | 00 | 02 | 01 | 01 | ff | 00 | ‘................ |
| 00000f0: | fe | 00 | 00 | 02 | 00 | 02 | 01 | 01 | ff | 00 | Fe | 00 | 00 | 4a | 00 | 00 | ‘.............J..’ |
| 0000100: | 00 | fa | f1 | 01 | 00 | 00 | 00 | 00 | 00 | 00 | 00 | 00 | 00 | 3a | 00 | 00 | ‘................ |
| 0000110: | 00 | 4a | 00 | 05 | 00 | 01 | 00 | 02 | 03 | 00 | 00 | 01 | 3b | 01 | ff | 01 | ‘.J..........;...’ |
| 0000120: | 00 | 02 | 03 | 01 | 3b | 01 | ff | 01 | 3b | 02 | 00 | 01 | 01 | 01 | 3b | 01 | ‘....;...;.....;.’ |
| 0000130: | 01 | 01 | 3b | 01 | 00 | 00 | 03 | 01 | 3b | 01 | Ff | 01 | 3b | 01 | 00 | 00 | ‘..;.....;...;...’ |
| 0000140: | 03 | 01 | ff | 01 | 3b | 00 | 00 | | | | | | | | | | ’....;..’ |

The FLIC file starts with the standard header that occupies bytes. 0×00 to 0×2b. It is to be noted that Little Endian encoding is used so that the least significant byte appears first.

Thus the first frame starts at an offset of 0×2c and the first chunk starts at an offset of 0×3c since the size of the frame header is 16 bytes. From the hex dump above, the following information can be obtained regarding the information chunk.. The chunk body starts at offset of 0×42 and is as follows:—

| | |
|---|---|
| FlicType = 3 | ALPHA FLIC with 16 bit data per pixel |
| HasAlpha = 1 | Has ALPHA component |
| nPAL = 1 | Only one palette |
| PalOffset0=0xa = 10 | The first palette offset starts at offset 0xa from |
| | the start of the chunk body, so it is at |
| | 0x42+0xa=0x4c. The palette has only 2 entries |
| | in BGRA form: |
| 0x00000ff - black | (entry 0) |
| 0x0000ffff - red | (entry 1) |

The second chunk starts at offset 0×54. Its size is 0×15 and its type is 0×49; It is the actual Frame 1 image compressed using RLE. The first packet is 0×05 0×00 0×00 (starting at offset 0×5a)—this means that there is a repetition of five 16 bit pixel values of 0×0000. The LSB=0, so it is palette entry 0 (black) and ALPHA value 0 (fully transparent, so the black colour is not visible). The second packet is identical to the first —another 5 transparent pixels. The third packet is 0×0 5 0×01 0×ff—so it is palette entry 1 (red), fully opaque, since ALPHA=0×ff, repeated 5 times. There are then another two packets that are identical to the first two. The final result of decoding the first frame to provide the image 10 is therefore:

| B G R A | B G R A | B G R A | B G R A | B G R A |
|---|---|---|---|---|
| 00 00 00 00 | 00 00 00 00 | 00 00 00 00 | 00 00 00 00 | 00 00 00 00 |
| 00 00 00 00 | 00 00 00 00 | 00 00 00 00 | 00 00 00 00 | 00 00 00 00 |
| 00 00 ff ff | 00 00 ff ff | 00 00 ff ff | 00 00 ff ff | 00 00 ff ff |
| 00 00 00 00 | 00 00 00 00 | 00 00 00 00 | 00 00 00 00 | 00 00 00 00 |
| 00 00 00 00 | 00 00 00 00 | 00 00 00 00 | 00 00 00 00 | 00 00 00 00 |

For the image 12, the frame, being the next frame, starts at offset 0×69. It has only one chunk starting at 0×79. This chunk is the modified Word Delta FLC chunk (0×4a) and its length is 0×3a=58. As described above, the first word following the chunk header gives the number of lines. In this case it is 5 since, in comparison with Frame 2, Frame 1 has all 5 lines different. The opcode for the first line is located at offset 0×81 and its value is 0×0001, meaning that this line contains only one packet. The packet header is 0×0002 (column skip=0, literal pixel count=2), so the next two words following (0×ff 01 and 0×3b01) are pixel values. The first word is fully opaque red (ALPHA=0×ff, entry 1 in palette), while the second word is also red, but in this case only about 25% opaque, since ALPHA=0×3b. Since the first line is now complete, the data following at offset 0×89 is opcode=0×001 (one packet) followed by packet header 0×003 (column skip=0, literal pixel count=3), followed by 3 pixel values (0×3b01 0×ff01 0×3b01). The data corresponding to the rest of the lines is decoded in similar manner, so that the decoded Frame 2 for image 12 becomes

| B G R A | B G R A | B G R A | B G R A | B G R A |
|---|---|---|---|---|
| 00 00 ff ff | 00 00 ff 3b | 00 00 00 00 | 00 00 00 00 | 00 00 00 00 |
| 00 00 ff 3b | 00 00 ff ff | 00 00 ff 3b | 00 00 00 00 | 00 00 00 00 |
| 00 00 00 00 | 00 00 ff 3b | 00 00 ff ff | 00 00 ff 3b | 00 00 00 00 |
| 00 00 00 00 | 00 00 00 00 | 00 00 ff 3b | 00 00 ff ff | 00 00 ff 3b |
| 00 00 00 00 | 00 00 00 00 | 00 00 00 00 | 00 00 ff 3b | 00 00 ff ff |

The frames for images 14 and 16 are decoded in a similar way to provide those images.

Accordingly, it is an advantage of the invention that a format is provided which enables ALPHA information to be incorporated in compressed data so that the information can be run from an EPROM of the gaming machine. This frees up the video memory of the gaming machine for other uses. The incorporation of the ALPHA component into the FLIC file format also considerably increases the speed with which the information can be decompressed and the images generated in a format suitable for use in gaming machines. This results in a more seamless operation in the-generation of the images.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

What is claimed is:

1. A system for generating animated images, the system comprising
a data encoder for compressing data relating to the animated image to be generated using a predetermined compression format;
a transparency information component embodied in the data, the transparency information component providing information relating to a degree of transparency of a part of the image; and
an identification component contained in the data that identifies to a data decoder the compression format that has been used to compress the data.

2. The system of claim 1 in which the compression format used by the data encoder and the data decoder is a FLIC file format.

3. The system of claim 2 in which the transparency information component embodies ALPHA information incorporated in the FLIC file format so that, together with color information in the FLIC file format, a data word specifying color and transparency of each pixel of the image is created.

4. The system of claim 2 in which the identification component is an information chunk incorporated in a first chunk of a first frame of the FLIC file format to enable the decoder to determine that a different FLIC file format is being used.

5. The system of claim 4 in which the information chunk contains information as to whether or not the FLIC file format being used does contain any ALPHA information.

6. The system of claim 4 in which the information chunk contains information relating to a color palette used in the FLIC file format.

7. The system of claim 6 in which, where more than one color palette is available for use, a palette change chunk is included in the data following the information chunk to enable a palette change to be effected.

8. A method of generating animated images which includes the steps of
compressing data relating to the animated image to be generated using a predetermined compression format;
including a transparency information component in the data for enabling a determination to be made as to a degree of transparency of a part of the image; and
incorporating an identification component in the data that identifies to a data decoder the compression format that has been used to compress the data.

9. The method of claim 8 which includes using a FLIC file format as the compression format.

10. The method of claim 9 which includes embodying the transparency information component as ALPHA information incorporated in the FLIC file format so that, together with color information in the FLIC file format, a data word specifying color and transparency of each pixel of the image is created.

11. The method of claim 9 which includes implementing the identification component as an information chunk incorporated in a first chunk of a first frame of the FLIC file format to enable the decoder to determine that a different FLIC file format is being used.

12. The method of claim 11 which includes inserting in the information chunk information as to whether or not the FLIC file format being used does contain any ALPHA information.

13. The method of claim 11 which includes inserting in the information chunk information relating to a color palette used in the FLIC file format.

14. The method of claim 13 which includes, where more than one color palette is available for use, including a palette change chunk in the data following the information chunk to enable a palette change to be effected.

15. A method of modifying software used in the generation of animated images, the method including inserting a transparency information component and an identification component into a part of a data file, the identification component identifying to a data decoder the compression format that has been used to compress the data.

16. The method of claim 15 in which the data file is a FLIC format file and the method includes inserting the transparency information component into at least one chunk of the FLIC file.

17. The method of claim 15 which includes implementing the transparency information component by way of an ALPHA technique by incorporating an ALPHA component in the data file to be compressed and decompressed in generating a sequence of images.

18. The method of claim 17 which includes modifying a data file of the FLIC file format to incorporate the ALPHA component by including a second byte of data relating to the ALPHA component.

19. The method of claim 18 which includes modifying a run chunk of the FLIC file format so that data following a chunk header is a full image that is compressed with one of word oriented run length encoding (RLE) and Huffman encoding.

20. The method of claim 19 in which, where RLE is used, each packet of RLE data consists of a count byte and at least one data word.

21. The method of claim 20 which includes expanding the data word to BGRA.

22. The method of claim 21 which includes expanding the data word by using the least significant byte to get BGR information from a BGR color palette with the ALPHA component being taken from the most significant byte of the data word.

23. The method of claim 16 which includes inserting the identification component as an information chunk into a first chunk of a first frame of the FLIC file format.

24. The method of claim 16 which includes inserting a palette change chunk into the data file where more than one palette is contained in the information chunk.

25. A data carrying signal which includes compressed data relating to an animated image to be displayed, the data incorporating color related information, transparency related information and an identification component embodied in chunk components of the data, the identification component identifying to a data decoder the compression format that has been used to compress the data.

26. A gaming apparatus which includes a game controller and a display, the game controller controlling the display of images related to a game played on the gaming machine on the display, the game controller including a system as claimed in claim 1 for generating animated images to be displayed on the display.
